(19) United States
(12) Patent Application Publication
(10) Pub. No.: US 2022/0366212 A1
(43) Pub. Date: Nov. 17, 2022

(54) METHOD FOR FAULT DIAGNOSIS IN COMMUNICATION NETWORK

(71) Applicant: National Yang Ming Chiao Tung University, Hsinchu City (TW)

(72) Inventors: Ta-Sung Lee, Hsinchu City (TW); Yen-Jung Wu, Kaohsiung City (TW); Kuan-Fu Chen, New Taipei City (TW); Ting-Yen Kuo, Kinmen County (TW)

(73) Assignee: National Yang Ming Chiao Tung University, Hsinchu City (TW)

(21) Appl. No.: 17/386,682

(22) Filed: Jul. 28, 2021

(30) Foreign Application Priority Data
May 12, 2021 (TW) 110117144

(51) Int. Cl. G06N 3/04; G06N 3/08; H04B 17/17

(52) U.S. Cl. CPC G06N 3/04; G06N 3/08; H04B 17/17

(57) ABSTRACT

A method for fault diagnosis in a communication network is to be implemented by a processor. The method includes obtaining key performance indicator (KPI) data related to the communication network, performing a deep-learning-based classification algorithm by using the KPI data as input to a deep neural network model, and determining, based on output of the deep neural network model after performing the deep-learning-based classification algorithm, at least one type of network condition the communication network currently satisfies, and a severity level of the at least one type of network condition when the output of the deep neural network model contains information related to severity levels of the at least one type of network condition.

### CROSS-REFERENCE TO RELATED APPLICATION

This application claims priority of Taiwanese Invention Patent Application No. 110117144, filed on May 12, 2021.

### FIELD

The disclosure relates to a method for fault diagnosis in a network, and more particularly to a method for fault diagnosis in a communication network by using machine learning.

### BACKGROUND

A conventional machine learning based approach for fault diagnosis in a mobile communication network is developed under the premise that only a single type of fault may occur in the mobile communication network, and is implemented by using a support-vector machine (SVM) classifier. That is to say, the SVM classifier used in the conventional machine learning based approach is only capable of detecting a single type of fault in the mobile communication network. Therefore, to diagnose multiple faults in a mobile communication network by using the conventional machine learning based approach, training of multiple SVM classifiers for respective faults is required beforehand, thereby raising computational complexity and costs for multi-fault detection. Moreover, for the conventional machine learning based approach, a severity level of each fault is usually not taken into consideration.

### SUMMARY

Therefore, an object of the disclosure is to provide a method for fault diagnosis in a communication network that can alleviate at least one of the drawbacks of the prior art.

According to the disclosure, the method is to be implemented by a processor. The method includes steps of:

obtaining key performance indicator (KPI) data related to the communication network;

performing a deep-learning-based classification algorithm by using the KPI data as input to a deep neural network model; and

determining, based on output of the deep neural network model after performing the deep-learning-based classification algorithm, at least one type of network condition the communication network currently satisfies, and a severity level of the at least one type of network condition when the output of the deep neural network model contains information related to severity levels of the at least one type of network condition.

### BRIEF DESCRIPTION OF THE DRAWINGS

Other features and advantages of the disclosure will become apparent in the following detailed description of the embodiment with reference to the accompanying drawings, of which:

FIG. 1 is a flow chart illustrating an embodiment of a method for fault diagnosis in a communication network according to the disclosure;

FIG. 2 is a schematic diagram illustrating an embodiment of an attention neural network model and an example of the attention neural network model in the method according to the disclosure;

FIG. 3 is a schematic diagram illustrating an embodiment of a deep neural network model used in the method according to the disclosure;

FIG. 4 is a schematic diagram illustrating an embodiment of an architecture of training the attention neural network model and the deep neural network model; and

FIG. 5 is a schematic diagram illustrating embodiments of output nodes of the deep neural network model.

### DETAILED DESCRIPTION

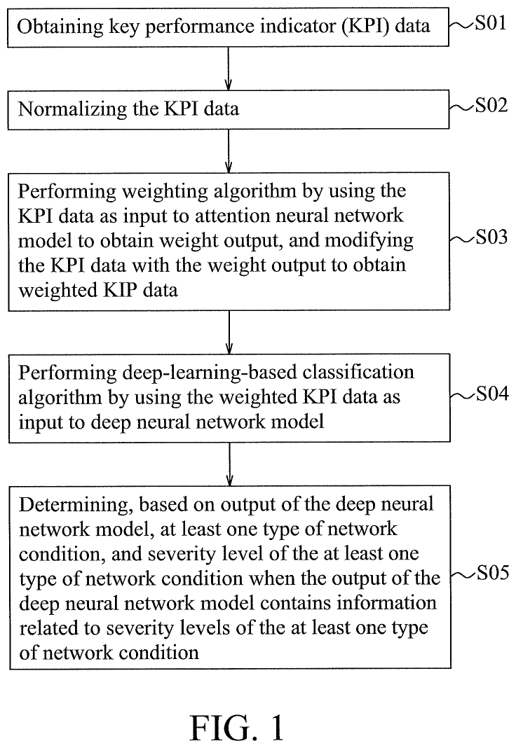

Referring to FIG. 1, an embodiment of a method for fault diagnosis in a communication network according to the disclosure is illustrated. In this embodiment, the communication network is a mobile communication network under the fourth generation technology standard (4G) for broadband cellular network technology. However, the method is not limited to being applied to 4G communication network, and is applicable to other generations of communication networks (e.g., 3G or 5G). The method is to be implemented by a processor (not shown) included in an electronic device (not shown). The electronic device may be a desktop computer, a laptop computer, a notebook computer, a tablet computer, a data server or a computing server, but is not limited to such.

In this embodiment, fault diagnosis in a communication network is meant to determine one or more types of network conditions the communication network currently satisfies. The types of network conditions include several fault conditions, namely, excessive antenna downtilt (EAD), excessive antenna uptilt (EAU), antenna fault (AF), coverage hole (CH), and excessive reduced power (ERP), and a normal condition. However, the types of network conditions are not limited to the disclosure herein and may vary in other embodiments.

The EAD is a situation that mechanical tilt of antennas of a base station in the communication network is excessively decreased, resulting in an abnormally small coverage area; the EAU is a situation that the mechanical tilt of antennas of a base station in the communication network is excessively increased, resulting in increased interference to neighboring cells of the base station or reduced signal quality for user equipments (e.g., mobile phones) near the base station. The AF is a situation that at least one of multiple antennas of a user equipment malfunctions and thus the user equipment no longer supports multiple-input multiple-output (MIMO), causing reduction in throughput and data rate. The CH is a situation that a service area of the communication network has a region where service cannot be maintained because the power of signal received by the user equipment is insufficient, which may be attributed to signal attenuation incurred by physical obstacles. The ERP is a situation that a base station in the communication network suffers from power supply failure due to wiring problems or incorrect parameter configurations, so power transmitted by the base station is significantly reduced and signal quality received by user equipments is adversely affected. The normal condition is a situation that none of the aforesaid five types of fault conditions (i.e., the SAD, the EAU, the AF, the CH and the ERP) has occurred.

The method includes steps S01 to S05 delineated below.

In Step S01, the processor obtains key performance indicator (KPI) data related to the communication network. It is worth to note that in this embodiment, the KPI data is measured by the operations support system (OSS) in each cell of the communication network, and is usually owned by a mobile network operator (e.g., AT&T Inc. or Chunghwa Telecom Company, Ltd.). However, in other embodiment, the KPI data may be generated by a communication network simulator, such as the Long-Term Evolution (LTE)-A Downlink System Level Simulator provided by the University of Vienna.

In this embodiment, the KPI data is related to downlink transmissions where a base station transmits signals to a user equipment (i.e., a mobile phone). The base station exemplarily includes four transmitting antennas and the user equipment exemplarily includes two antennas, but implementations of the base station and the user equipment are not limited thereto.

In this embodiment, the KPI data includes twelve KPIs including the 20th percentile of the channel quality indicator (CQI), the 80th percentile of the CQI, the 20th percentile of the reference signal received power (RSRP), the 80th percentile of the RSRP, the 20th percentile of the throughput, the 80th percentile of the throughput, the 20th percentile of the signal-to-interference-plus-noise ratio (SINR), the 80th percentile of the SINR, the 20^{th} percentile of the time advance (TA), the 80^{th} percentile of the TA, the rank indicator (RI) and the link failure indicator (LFI). However, the KPI data is not limited to the disclosure herein and may vary in other embodiments.

Specifically, the CQI carries information on the quality of the communication channel, and is proportional to the signal-to-noise ratio (SNR) of a reference signal. The RSRP is the power level of a reference signal received by the user equipment. The SINR indicates the quality of wireless connections, and is related to the signal propagation, the interference and the positioning of network transmitters and receivers. The TA indicates a distance between the user equipment and the base station. The RI is a rank of a channel matrix estimated by the user equipment, and is an index for judging correlation of the channel and selection of the transmission layer in downlink data transmission. The throughput is defined as a product of the RI and a transport block size divided by a transmission time interval. It is worth to note that the transport block size is decided by the CQI, and the CQI can be mapped to a specific modulation order and coding rate. The transmission time interval is equal to one millisecond under the LTE standards. The LFI stands for a total number of user equipments which have encountered link failures in a cell, and increases by one whenever a link failure occurs.

In step S02, the processor normalizes the KPI data such that for each of the KPIs, a value thereof ranges from zero to one and has a floating point data type. In this way, those KPIs that have particularly large range of values may be prevented from dominating a learning process that will follow. It should be noted that a part of the KPI data that is not originally recorded in a linear scale (e.g., the SINR, which is normally expressed in a logarithmic scale) will be linearized before normalization.

In step S03, the processor performs a weighting algorithm by using the KPI data as input to an attention neural network model to obtain weight output, and by modifying the KPI data with the weight output to obtain weighted KPI data. The values of the KPIs of the KPI data are arranged in the form of a vector for being used as the input. In particular, to modify the KPI data with the weight output, the processor performs the Hadamard product of the KPI data and the weight output of the attention neural network model. Since matrix manipulation is avoided herein, efficiency of computation may thereby be enhanced.

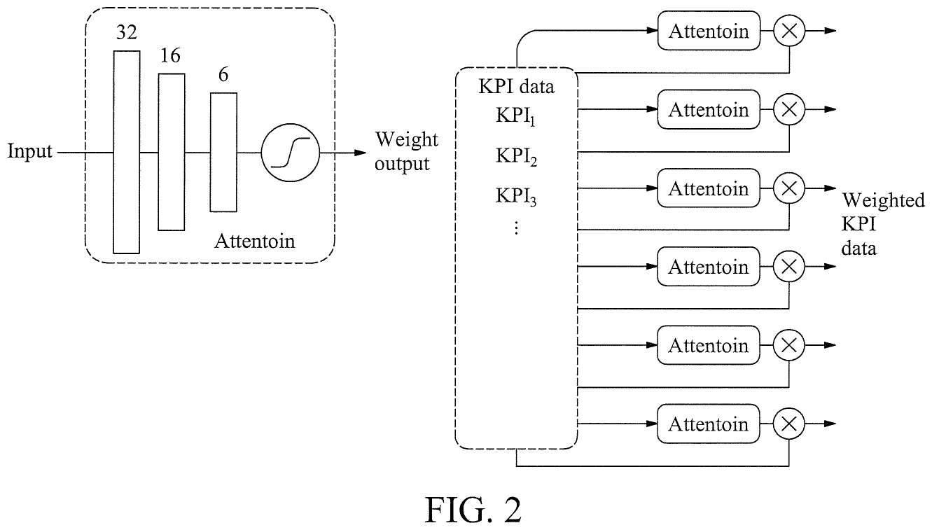

Referring to a left part of FIG. 2, in this embodiment, the attention neural network model (denoted by “Attention”) includes three hidden fully connected layers, which respectively include 32, 16 and 6 neurons as indicated by numbers beside the respective layers in FIG. 2. In addition, the softmax activation function is utilized to introduce a non-linear property to the attention neural network. By adopting the weighting algorithm, some KPIs of the KPI data that are more relevant to a particular type of network condition to be determined will be assigned with higher weights than the other KPIs of the KPI data that are less relevant to the particular type of network condition, and accuracy of diagnosis may thereby be improved. It should be noted that to determine six types of network conditions (i.e., the EAD, the EAU, the AF, the CH, the ERP and the normal condition), six copies of the attention neural network model with distinct parameters are used to generate weight outputs respectively for the six types of network conditions as shown in a right part of FIG. 2. Hadamard product is performed between the KPI data and each of the weight outputs individually to result in the corresponding weighted KPI data. Each value of the weighted KPI data ranges from zero to one and has a floating point data type.

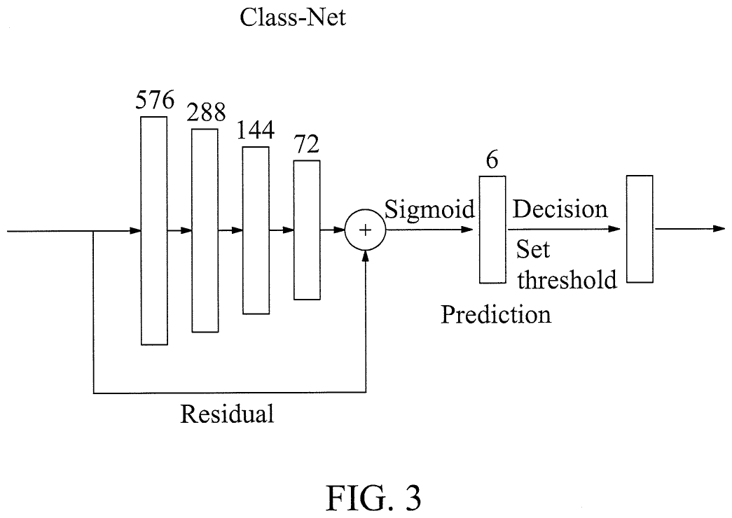

In step S04, the processor performs a deep-learning-based classification algorithm by using the weighted KPI data as input to a deep neural network model. As shown in FIG. 3, in this embodiment, the deep neural network model (denoted by “Class-Net”) includes five hidden fully connected layers, which respectively include 576, 288, 144, 72 and 6 neurons as indicated by numbers beside the respective layers in FIG. 3. It should be noted that decrement in the number of neurons from input of the deep neural network model to output of the deep neural network model helps refine information fed into the deep neural network model. In addition, the initial four layers of the five hidden fully connected layers of the deep neural network model utilize the rectified linear unit (ReLU) as activation functions, and the last layer of the five hidden fully connected layers of the deep neural network model utilizes the sigmoid function as an activation function. Moreover, the initial four layers of the five hidden fully connected layers of the deep neural network model have a residual neural network architecture as indicated in FIG. 3, which enables output of the deep neural network model to preserve features of the input of the deep neural network model and thereby benefits fault diagnosis. It is worth to note that an output value of the sigmoid activation function ranges from zero to one, and represents a confidence level of the output generated by the deep neural network model based on the input of the deep neural network model. In addition, each output value of the output of the deep neural network model ranges from zero to one and has a floating point data type.

In this embodiment, the deep neural network model is trained by using a stochastic gradient descent (SGD) method and an R-Loss function as a loss function. It should be noted that, for a mobile network operator, an undetected fault may cause more damage than a false alarm. Therefore, the R-loss function is designed to have a greater output value than the output value of a binary cross-entropy (BCE) function when the deep neural network model determines that no fault condition occurred while the fault condition has actually occurred. The fault condition refers to any one of the aforementioned six network conditions except for the normal condition (i.e., the EAD, the EAU, the AF, the CH and the ERP). More specifically, the R-Loss function is defined as R−Loss=y[log₂ f(x)]²−(1−y) log₂(1−f(x)), where x represents input of the deep neural network model, f(x) represents output of the deep neural network model and ranges from zero to one, and y represents a target corresponding to the input and is zero or one. By adopting the R-loss function to train the deep neural network model, miss detection rate of fault diagnosis, i.e., the possibility that a fault that had occurred but was undetected, may be reduced.

However, the loss function used to train the deep neural network model is not limited to the disclosure herein and may vary in other embodiments. For example, in one embodiment, the deep neural network model is trained by using the BCE function as the loss function. More specifically, the BCE function is defined as BCE=−y log₂f(x)−(1−y)log₂(1−f(x)), where x represents input of the deep neural network model, f(x) represents output of the deep neural network model and ranges from zero to one, and y represents a target corresponding to the input and is one of zero and one.

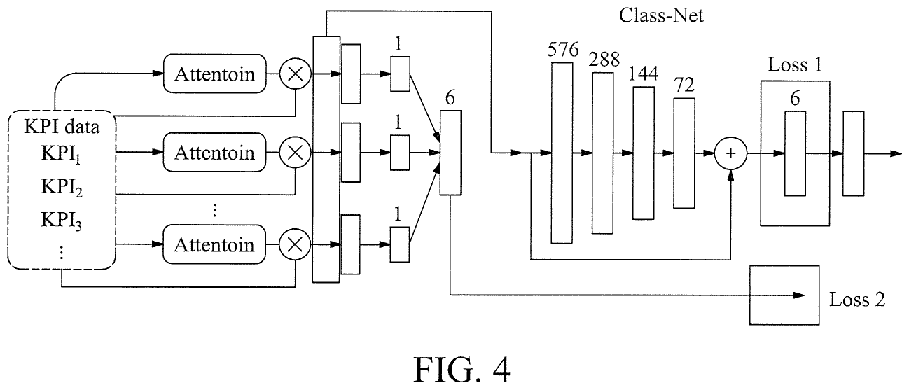

It is worth to note that the attention neural network model is trained together with the deep neural network model by performing an end-to-end training where six Hadamard product operators following the six copies of the attention neural network model are directly connected to the deep neural network model. Referring to FIG. 4, in one embodiment, besides the end-to-end training, additional fully-connected layers are connected to outputs of the Hadamard product operators following the six copies of the attention neural network model for specifically training the attention neural network model. In this embodiment, two loss functions are used, wherein one of the two loss functions (denoted by “Loss 1” shown in FIG. 4) is used for the end-to-end training, and the other of the two loss functions (denoted by “Loss 2” shown in FIG. 4) is dedicated for training the attention neural network model. Each of the two loss functions may be selected from one of the BCE function and the R-loss function based on demanded performance of the fault diagnosis.

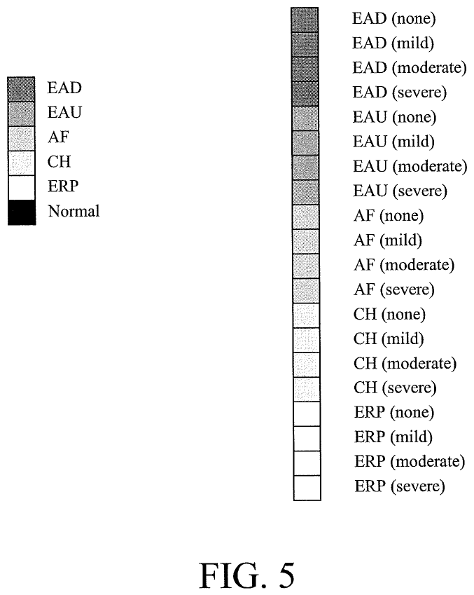

In step S05, the processor determines, based on the output of the deep neural network model after performing the deep-learning-based classification algorithm, at least one type of network condition the communication network currently satisfies. In this embodiment, the deep neural network model further includes an input layer (not shown) which includes 72 input nodes, and an output layer (see a left part of FIG. 5) which includes six output nodes respectively for the previously-mentioned six types of network conditions (i.e., the EAD, the EAU, the AF, the CH, the ERP and the normal condition). For each one of the six types of network conditions, the processor determines whether the type of network condition occurs by comparing a value of the output node of the deep neural network model representing the type of network condition with a threshold corresponding to the type of network condition. When it is determined that the value of the output node is greater than the threshold, the processor determines that the type of network condition has occurred.

In one embodiment, the processor further determines a severity level of the at least one type of network condition when the output of the deep neural network model contains information related to severity levels of the at least one type of network condition. In this embodiment, the deep neural network model further includes an input layer (not shown) which includes 72 input nodes, and an output layer which includes 20 output nodes as shown in a right part of FIG. 5. Specifically, for each one of five network (fault) conditions which include the EAD, the EAU, the AF, the CH and the ERP, four of the output nodes respectively represent four severity levels (i.e., none, mild, moderate and severe) of the network condition.

More specifically, in one embodiment, for each of the at least one type of network condition, the processor determines the severity level of the network condition to be a severity level which is represented by an output node having the greatest output value among plural output values of the output of the deep neural network model (e.g., output values of the four output nodes respectively representing none, mild, moderate and severe).

In one embodiment, for each of the at least one type of network condition, the processor determines the severity level of the network condition to be a severity level that is represented by a range which is among plural ranges defined by plural thresholds and in which an output value of an output node corresponding to the network condition falls.

In one embodiment, each threshold is set to be 0.5.

In one embodiment, each threshold is determined by grid search, wherein a validation set is fed into the deep neural network model that has been trained so as to obtain an optimal threshold for one of the severity levels of one of the network conditions.

In a scenario where the processor is going to determine at least one type of network condition the communication network currently satisfies and the KPI data that has been normalized by the processor is an input vector [0.87, 0.73, 0.0006, 0.0006, 0.5, 0.62, 0.58, 0.4, 0.65, 0.75, 1, 0.07], the processor uses the input vector to perform the weighting algorithm and the deep-learning-based classification algorithm in sequence so as to obtain an output vector [0.03, 0.94, 0.99, 0.004, 0.007, 0.01] as the output of the deep neural network model, where elements in the output vector from left to right respectively correspond to the EAD, the EAU, the AF, the CH, the ERP and the normal condition. When the threshold is set to be 0.5, the processor will output a decision vector [0, 1, 1, 0, 0, 0], which indicates that the EAU and the AF have occurred, as a result of the fault diagnosis in the communication network.

In a similar scenario where the processor is further going to determine a severity level of the at least one type of network condition, the processor uses the aforementioned input vector to perform the weighting algorithm and the deep-learning-based classification algorithm in sequence so as to obtain another output vector [0.61, 0.32, 0.17, 0.02, 0.62, 0.73, 0.58, 0.4, 0.16, 0.31, 0.9, 0.47, 0.85, 0.45, 0.11, 0.13, 0.95, 0.38, 0.17, 0.05] as the output of the deep neural network model that is designed and trained to predict severity levels of network condition(s), where elements in the another output vector from left to right respectively correspond to various severity levels of various types of network conditions, that is, the EAD (none), the EAD (mild), the EAD (moderate), the EAD (severe), the EAU (none), the EAU (mild), the EAU (moderate), the EAU (severe), the AF (none), the AF (mild), the AF (moderate), the AF (severe), the CH (none), the CH (mild), the CH (moderate), the CH (severe), the ERP (none), the ERP (mild), the ERP (moderate) and the ERP (severe). For each of the five types of network (fault) conditions, by determining the elements the has the greatest value among the four elements, the processor will output another decision vector [1, 0, 0, 0, 0, 1, 0, 0, 0, 0, 1, 0, 1, 0, 0, 0, 1, 0, 0, 0], which indicates that a mild level of the EAU and a moderate level of the AF have occurred, as a result of the fault diagnosis in the communication network.

In summary, the method for fault diagnosis in a communication network according to the disclosure adopts the weighting algorithm prior to performing classification for diagnosis, and hence, network information contained in the KPI data can be efficiently utilized and accuracy of diagnosis may thereby be improved. In addition, the deep neural network model used in the method for fault diagnosis is trained by adopting the R-loss function, which is designed to enhance the recall while maintaining the precision, as the loss function. Consequently, miss detection rate of the fault diagnosis, i.e., the possibility that a fault that had occurred but was undetected, may be reduced. Further, a single classifier (i.e., the deep neural network model) is sufficient in the method according to the disclosure to diagnose a communication network where multiple types of faults with varying levels of severity may occur. That is to say, the type and the severity level of each network condition can be determined at the same time. Since only a single classifier (i.e., the deep neural network model) is required for diagnosing multiple types of network conditions in the communication network, computational complexity and costs for training the classifier are reduced. Furthermore, by virtue of automatic diagnosis, efficiency of diagnosing network conditions may be enhanced, and time and manpower may be saved.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for fault diagnosis in a communication network, the method to be implemented by a processor, the method comprising:
obtaining key performance indicator (KPI) data related to the communication network;
performing a deep-learning-based classification algorithm by using the KPI data as input to a deep neural network model; and
determining, based on output of the deep neural network model after performing the deep-learning-based classification algorithm, at least one type of network condition the communication network currently satisfies, and a severity level of the at least one type of network condition when the output of the deep neural network model contains information related to severity levels of the at least one type of network condition.

2. The method as claimed in claim 1, prior to performing a deep-learning-based classification algorithm, further comprising:
performing a weighting algorithm by using the KPI data as input to an attention neural network model to obtain weight output, and by modifying the KPI data with the weight output to obtain weighted KPI data;
wherein performing a deep-learning-based classification algorithm includes performing the deep-learning-based classification algorithm by using the weighted KPI data as the input to the deep neural network model.

3. The method as claimed in claim 2, wherein modifying the KPI data with the weight output includes performing the Hadamard product of the KPI data and the weight output of the attention neural network model.

4. The method as claimed in claim 2, wherein the attention neural network model includes three hidden fully connected layers, which respectively include 32, 16 and 6 neurons.

5. The method as claimed in claim 2, wherein the attention neural network model utilizes the softmax function as the activation function.

6. The method as claimed in claim 1, wherein the deep neural network model is trained by using an R-Loss function as a loss function, the R-loss function having a greater output value than a binary cross-entropy (BCE) function when it is determined by the deep neural network model that no fault condition occurred while the fault condition has actually occurred.

7. The method as claimed in claim 6, wherein the R-Loss function is defined as R−Loss=y[log₂ f(x)]²−(1−y)log₂(1−f(x)), where x represents the input of the deep neural network model, f(x) represents the output of the deep neural network model and ranges from zero to one, and y represents a target corresponding to the input and is one of zero and one.

8. The method as claimed in claim 6, wherein the deep neural network model is trained by using the R-Loss function and a stochastic gradient descend (SGD) method.

9. The method as claimed in claim 1, wherein the deep neural network model is trained by using a binary cross-entropy (BCE) function.

10. The method as claimed in claim 9, wherein the BCE function is defined as BCE=−ylog₂ f(x)— (1−y)log₂(1−f(x)), where x represents the input of the deep neural network model, f(x) represents the output of the deep neural network model and ranges from zero to one, and y represents a target corresponding to the input and is one of zero and one.

11. The method as claimed in claim 1, wherein the deep neural network model includes five hidden fully connected layers, which respectively include 576, 288, 144, 72 and 6 neurons.

12. The method as claimed in claim 11, wherein the initial four layers of the five hidden fully connected layers of the deep neural network model utilize the rectified linear unit (ReLU) activation function.

13. The method as claimed in claim 11, wherein the last layer of the five hidden fully connected layers of the deep neural network model utilizes a sigmoid function as the activation function.

14. The method as claimed in claim 11, wherein the initial four layers of the five hidden fully connected layers of the deep neural network model have a residual neural network architecture.

15. The method as claimed in claim 1, wherein the KPI data includes one of the 20^{th} percentile of the channel quality indicator (CQI), the 80^{th} percentile of the CQI, the 20^{th} percentile of the reference signal received power (RSRP), the 80^{th} percentile of the RSRP, the 20^{th} percentile of the throughput, the 80^{th} percentile of the throughput, the 20^{th} percentile of the signal-to-interference-plus-noise ratio (SINR), the 80^{th} percentile of the SINR, the 20^{th} percentile of the time advance (TA), the 80^{th} percentile of the TA, the rank indicator (RI), the link failure indicator (LFI) and combinations thereof.

16. The method as claimed in claim 1, wherein the type of network condition to be determined includes one of excessive antenna downtilt (EAD), excessive antenna uptilt (EAU), antenna fault (AF), coverage hole (CH), excessive reduced power (ERP), a normal condition and combinations thereof.

17. The method as claimed in claim 1, subsequent to obtaining KPI data, further comprising:
normalizing the KPI data such that each value thereof ranges from zero to one.

18. The method as claimed in claim 1, wherein determining a severity level of the at least one type of network condition includes, for each of the at least one type of network condition, determining the severity level of the network condition to be a severity level which is represented by an output node having the greatest output value among plural output values of the output of the deep neural network model.

19. The method as claimed in claim 1, wherein determining a severity level of the at least one type of network condition includes, for each of the at least one type of network condition, determining the severity level of the network condition to be a severity level that is represented by a range which is among plural ranges defined by plural thresholds and in which an output value of an output node corresponding to the network condition falls.

20. The method as claimed in claim 19, wherein the plural thresholds are determined by grid search.
